(19) United States
(12) Patent Application Publication
(10) Pub. No.: US 2026/0365047 A1
(43) Pub. Date: Nov. 19, 2026

(54) FUEL CELL VEHICLE AND METHOD OF CONTROLLING THE SAME

(71) Applicants: HYUNDAI MOTOR COMPANY, SEOUL (KR); KIA CORPORATION, SEOUL (KR)

(72) Inventors: Yoon Tae Kim, Hwaseong-si (KR); Woo Young Lee, Hwaseong-si (KR); Ki Wook Ohm, Hwaseong-si (KR); Joo Seung Lee, Hwaseong-si (KR); Hyeon Ju Jeong, Hwaseong-si (KR); Jae Ho Kim, Hwaseong-si (KR); Sae Kwon Chang, Hwaseong-si (KR); Jong Jun Lee, Hwaseong-si (KR)

(73) Assignees: HYUNDAI MOTOR COMPANY, SEOUL (KR); KIA CORPORATION, SEOUL (KR)

(21) Appl. No.: 19/395,765

(22) Filed: Nov. 20, 2025

(30) Foreign Application Priority Data
May 13, 2025 (KR) 10-2025-0061906

(51) Int. Cl. B60L 50/75; B60L 53/20; B60L 58/30

(52) U.S. Cl. CPC B60L 50/75; B60L 53/20; B60L 58/30; B60L 2210/14; B60L 2240/526

(57) ABSTRACT

A method of controlling a fuel cell vehicle is provided. The fuel cell vehicle includes a fuel cell, a voltage level converter having a plurality of boost converters connected in parallel to each other and configured to boost stack voltage generated by the fuel cell, and a battery configured to store voltage output from the voltage level converter. The method includes: activating an arbitrary boost converter among the plurality of boost converters; determining an increase reference value based on the number of first target boost converters eligible for additional activation among the plurality of boost converters; additionally activating one of the first target boost converters based on determining that a power command value of the voltage level converter is equal to or greater than the increase reference value; and performing determining the increase reference value based on determining that any of the first target boost converters to be additionally activated remain.

### CROSS REFERENCE TO RELATED APPLICATIONS

This application claims the benefit of and priority to Korean Patent Application No. 10-2025-0061906, filed on May 13, 2025, which is hereby incorporated by reference in its entirety.

### BACKGROUND

### Technical Field

The present disclosure relates to a fuel cell vehicle and a method of controlling the same.

### Discussion of the Related Art

A fuel cell vehicle includes a fuel cell and a high-voltage boost DC/DC converter (or a fuel cell DC/DC converter (FDC)). The FDC is a boost converter that controls power output from the fuel cell. Due to the FDC, even when high-voltage components of the vehicle or loads such as an inverter and a driving motor operate or stop operating, the fuel cell may remain unaffected.

The FDC may control the voltage and the current of a cell stack of the fuel cell to regulate power output from the cell stack. Even when a load connected to an output end of the FDC stops operating, the cell stack of the fuel cell may generate only desired output due to the FDC. If output from the loads of the vehicle is greater than output from the cell stack, power may be discharged from a high-voltage battery, and if output from the loads of the vehicle is less than output from the cell stack, power may be stored in the high-voltage battery. In other words, output from the fuel cell stack may be controlled regardless of variation in output from the loads, whereby the cell stack may be reliably protected, and the durability thereof may be ensured.

In order to reduce the cost of components of an FDC (i.e., an inductor, a capacitor, a semiconductor switch, and a diode), a plurality of boost converters may be connected in parallel to implement an FDC (hereinafter referred to as a “multiphase FDC”). Research is being conducted to enhance durability by efficiently driving a plurality of boost converters in a multiphase FDC.

### SUMMARY

Accordingly, embodiments are directed to a fuel cell vehicle and a method of controlling the same that substantially obviate one or more problems due to limitations and disadvantages of the related art.

Embodiments provide a fuel cell vehicle having improved durability by efficiently driving a plurality of boost converters and a method of controlling the same.

However, the aspects to be accomplished by the embodiments are not limited to the above-mentioned aspects, and other aspects not mentioned herein should be clearly understood by those having ordinary skill in the art from the following description.

Additional advantages, aspects, and features of the disclosure are set forth in part in the description which follows and in part should become apparent to those having ordinary skill in the art upon examination of the following or may be learned from practice of the disclosure. The aspects and other advantages of the disclosure may be realized and attained by the structure particularly pointed out in the written description and claims hereof as well as the appended drawings.

According to an embodiment, a method of controlling a fuel cell vehicle is provided. The fuel cell vehicle includes a fuel cell, a voltage level converter having a plurality of boost converters connected in parallel to each other and configured to boost stack voltage generated by the fuel cell, and a battery configured to store voltage output from the voltage level converter. The method may include: activating an arbitrary boost converter among the plurality of boost converters; determining an increase reference value based on a number of first target boost converters eligible for additional activation among the plurality of boost converters; and additionally activating one of the first target boost converters based on determining that a power command value of the voltage level converter is equal to or greater than the increase reference value. The method further includes determining whether any of the first target boost converters to be additionally activated remain, and proceeding to determining the increase reference value based on determining that any of the first target boost converters to be additionally activated remain.

In an example, one of the first target boost converters to be additionally activated may be sequentially selected.

In an example, one of the first target boost converters to be additionally activated may be randomly selected.

In an example, the increase reference value may be determined as follows:

$$R H = \frac{T H}{( K - 1 )}$$

RH represents the increase reference value, TH represents a predetermined increase threshold, and K represents the number of first target boost converters.

In an example, the method may further include determining a decrease reference value based on a number of second target boost converters eligible for deactivation among the plurality of boost converters, and deactivating one of the second target boost converters based on determining that a subsequent power command value received following the power command value is less than the decrease reference value. The method also includes determining whether any of the second target boost converters to be additionally deactivated remain, and proceeding to determining the decrease reference value based on determining that any of the second target boost converters to be additionally deactivated remain.

In an example, one of the second target boost converters to be deactivated may be sequentially selected.

In an example, one of the second target boost converters to be deactivated may be randomly selected.

In an example, the decrease reference value may be determined as follows:

$$R L = \frac{T L}{( H - 1 )}$$

RL represents the decrease reference value, TL represents a predetermined decrease threshold, and H represents the number of second target boost converters.

In an example, the method may further include proceeding to determining the increase reference value based on determining that the subsequent power command value is equal to or greater than the decrease reference value.

In an example, the method may further include receiving the power command value based on determining operation of the voltage level converter, and receiving the subsequent power command value based on determining that none of the first or second target boost converters to be additionally activated or deactivated remain or that the power command value is less than the increase reference value.

In an example, the method may further include determining whether the subsequent power command value is 0, proceeding to determining the decrease reference value based on determining that the subsequent power command value is not 0, and determining whether to deactivate the voltage level converter based on determining that the subsequent power command value is 0.

According to another embodiment, a method of controlling a fuel cell vehicle is provided. The fuel cell vehicle includes a fuel cell, a voltage level converter having first to N^{th} (N being a positive integer of 2 or greater) boost converters connected in parallel to each other and configured to boost stack voltage generated by the fuel cell, and a battery configured to store voltage output from the voltage level converter. The method may include: (I) activating an n^{th} (1≤n≤N−1) boost converter among the first to N^{th} boost converters; and (II) determining whether a power command value of the voltage level converter is equal to or greater than an increase reference value. The increased reference value is defined as follows:

$$R H = \frac{T H}{( N - y )}$$

RH represents the increase reference value, TH represents a predetermined increase threshold, and y represents a first variable initially set to 0. The method also includes: (III) additionally activating an (n+x)^{th} target boost converter (x being a second variable initially set to 1); (IV) incrementing the first variable and the second variable by 1; (V) determining whether y is less than N−1; (VI) determining whether n+x is greater than N based on determining that y is less than N−1 and proceeding to step (II) based on determining that n+x is not greater than N; and (VII) changing x to 1−n based on determining that n+x is greater than N and proceeding to step (II).

In an example, the method may further include: (VIII) decrementing y by 1 and changing x to 0 based on determining that y is not less than N−1; (IX) receiving a new power command value; and (X) determining whether the new power command value is less than a decrease reference value based on determining that the new power command value is not 0 and proceeding to step (II) based on determining that the new power command value is equal to or greater than the decrease reference value. The decrease reference value is defined as:

$$R L = \frac{T L}{( N - y )}$$

RL represents the decrease reference value, and TL represents a predetermined decrease threshold. The method also includes: (XI) deactivating the (n+x)^{th} boost converter based on determining that the new power command value is less than the decrease reference value; (XII) incrementing x by 1 and decrementing y by 1; (XIII) determining whether y is greater than −1 and proceeding to step (IX) based on determining that y is not greater than −1; (XIV) determining whether n+x is greater than N based on determining that y is greater than −1 and proceeding to step (X) based on determining that n+x is not greater than N; and (XV) changing x to 1−n based on determining that n+x is greater than N and proceeding to step (X).

In an example, the method may further include determining whether to deactivate the voltage level converter based on determining that the new power command value is 0.

According to still another embodiment, a method of controlling a fuel cell vehicle is provided. The fuel cell vehicle includes a fuel cell, a voltage level converter having first to N^{th} (N being a positive integer of 2 or greater) boost converters connected in parallel to each other and configured to boost stack voltage generated by the fuel cell, and a battery configured to store voltage output from the voltage level converter. The method may include: (I) activating an arbitrary boost converter among the first to N^{th} boost converters; and (II) determining whether a power command value of the voltage level converter is equal to or greater than an increase reference value defined as follows:

$$R H = \frac{T H}{( N - y )}$$

RH represents the increase reference value, TH represents a predetermined increase threshold, and y represents a first variable initially set to 0. The method also includes: (III) randomly selecting and additionally activating one of first target boost converters eligible for additional activation among the first to N^{th} boost converters; (IV) incrementing y by 1; and (V) determining whether y is less than N−1 and proceeding to step (II) based on determining that y is less than N−1.

In an example, the method may further include: (VI) decrementing y by 1 based on determining that y is not less than N−1; (VII) receiving a new power command value; (VIII) determining whether the new power command value is less than a decrease reference value based on determining that the new power command value is not 0 and proceeding to step (II) based on determining that the new power command value is equal to or greater than the decrease reference value. The decrease reference value is defined as:

$$R L = \frac{T L}{( N - y )}$$

RL represents the decrease reference value, and TL represents a predetermined decrease threshold. The method also includes: (IX) randomly selecting and deactivating one of second target boost converters eligible for additional deactivation among the first to N^{th} boost converters based on determining that the new power command value is less than the decrease reference value; (X) decrementing y by 1; and (XI) determining whether y is greater than −1, proceeding to step (VII) based on determining that y is not greater than −1, and proceeding to step (VIII) based on determining that y is greater than −1.

In an example, the method may further include determining whether to deactivate the voltage level converter based on determining that the new power command value is 0.

A fuel cell vehicle according to still another embodiment may include a fuel cell having a cell stack and configured to generate stack voltage, a voltage level converter having a plurality of boost converters connected in parallel to each other and configured to boost the stack voltage generated by the fuel cell based on control signals, a battery configured to store voltage output from the voltage level converter, and a controller. The controller is configured to generate the control signals based on a comparison between an increase reference value, and a power command value of the voltage level converter. The increase reference value is determined based on the number of first target boost converters eligible for additional activation among the plurality of boost converters. The controller is also configured to generate the control signals based on a result of determining whether any of the first target boost converters to be additionally activated remain.

In an example, the controller may generate the control signals based on a comparison between a decrease reference value, and the power command value of the voltage level converter, and based on a result of determining whether any of the second target boost converters to be deactivated remain. The decrease reference value is determined based on the number of second target boost converters eligible for deactivation among the plurality of boost converters.

In an example, the controller may sequentially or randomly select, respectively, one of the first target boost converters to be additionally activated and one of the second target boost converters to be deactivated to generate the control signals.

It is to be understood that both the foregoing general description and the following detailed description of the present disclosure are exemplary and explanatory and are intended to provide further explanation of the disclosure as claimed.

### BRIEF DESCRIPTION OF THE FIGURES

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 is a block diagram of a fuel cell vehicle according to an embodiment;

FIG. 2 is a view showing an embodiment of a voltage level converter of the fuel cell vehicle shown in FIG. 1;

FIG. 3 is a circuit diagram of an embodiment of the voltage level converter shown in FIG. 2;

FIG. 4 is a flowchart showing a method of controlling a fuel cell vehicle according to an embodiment;

FIG. 5 is a flowchart showing an embodiment of the method of controlling the fuel cell vehicle shown in FIG. 4; and

FIG. 6 is a flowchart showing another embodiment of the method of controlling the fuel cell vehicle shown in FIG. 4.

### DETAILED DESCRIPTION

The present disclosure is described more fully hereinafter with reference to the accompanying drawings, in which various embodiments are shown. The examples, however, may be embodied in many different forms, and should not be construed as being limited to the embodiments set forth herein. Rather, these embodiments are provided so that this disclosure is more thorough and complete, and fully conveys the scope of the disclosure to those having ordinary skill in the art.

It should be understood that when an element is referred to as being “on” or “under” another element, it may be directly on/under the element, or one or more intervening elements may also be present.

When an element is referred to as being “on” or “under,” “under the element” as well as “on the element” may be included based on the element.

In addition, relational terms, such as “first,” “second,” “on/upper part/above,” and “under/lower part/below” are used only to distinguish between one subject or element and another subject or element, without necessarily requiring or involving any physical or logical relationship or sequence between the subjects or elements.

When a controller, component, device, element, part, unit, module, or the like of the present disclosure is described as having a purpose or performing an operating, function, or the like, the controller, component, device, element, part, unit, or module should be considered herein as being “configured to” meet that purpose or perform that operating or function. Each controller, component, device, element, part, unit, module, and the like may separately embody or be included with a processor and a memory, such as a non-transitory computer-readable media, as part of the apparatus.

Hereinafter, a fuel cell vehicle 100 according to an embodiment is described with reference to the accompanying drawings.

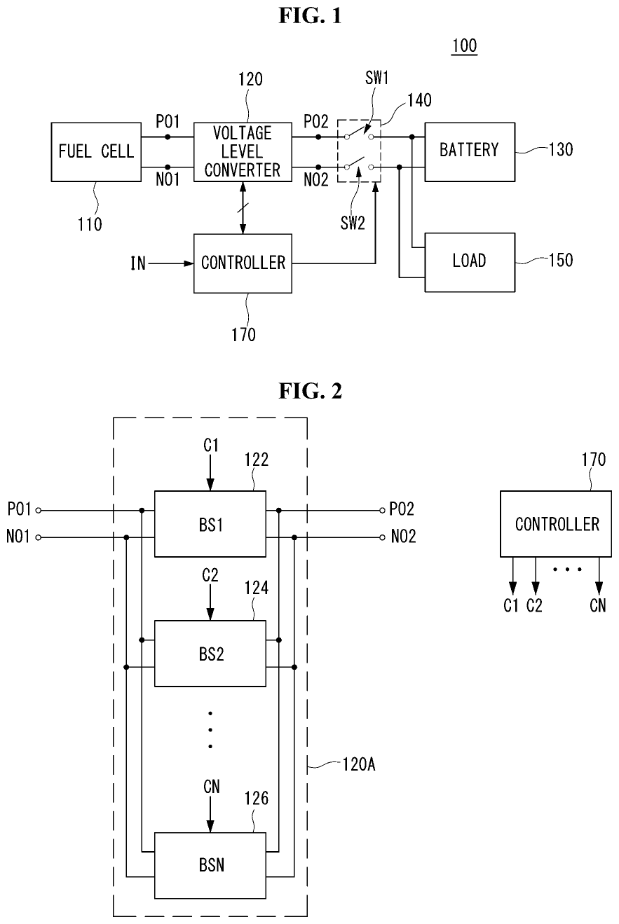

FIG. 1 is a block diagram of a fuel cell vehicle 100 according to an embodiment. The fuel cell vehicle 100 may include a fuel cell 110, a voltage level converter 120, a battery (or a high-voltage battery) 130, and a controller 170. In addition, the fuel cell vehicle 100 may further include a load 150.

The fuel cell 110 may include a plurality of unit fuel cells stacked in at least one of a vertical direction or a horizontal direction. The unit fuel cell may be a polymer electrolyte membrane fuel cell (or a proton exchange membrane fuel cell) (PEMFC), which has been studied most extensively as a power source for driving fuel cell vehicles. However, the embodiments are not limited to any specific form, configuration, or appearance of the unit fuel cell.

The unit fuel cell included in the fuel cell 110 may include end plates (pressing plates or compression plates) (not shown), current collectors (not shown), and a cell stack (not shown).

The cell stack may include a plurality of unit cells stacked in the horizontal direction. Tens to hundreds of unit cells, for example, 100 to 400 unit cells, may be stacked to form the cell stack. The number of unit fuel cells included in the fuel cell 110 and the number of unit cells included in the cell stack of the unit fuel cell may be determined depending on the intensity of power to be supplied from the fuel cell 110 to the load 150. For example, the load 150 is a part that requires power in the fuel cell vehicle 100. The load 150 is described below.

The end plates may be disposed at respective ends of the cell stack and may support and fix the plurality of unit cells. In other words, a first end plate may be disposed at one of the two opposite ends of the cell stack, and a second end plate may be disposed at the other of the two opposite ends of the cell stack.

In addition, the fuel cell 110 may further include a clamping member (not shown), which has a bar shape, a long bolt shape, a belt shape, or a rigid rope shape to clamp the plurality of unit cells. For example, in each unit fuel cell, the clamping member serves to clamp the plurality of unit cells in the horizontal direction together with the end plates.

The voltage level converter 120 boosts the stack voltage generated by the fuel cell 110 in response to a control signal, and outputs the boosted voltage to the battery 130 or the load 150. For example, the voltage level converter 120 may include a high-voltage boost DC/DC converter (or a fuel cell DC/DC converter (FDC)). Hereinafter, the voltage level converter 120 is referred to as an “FDC”.

Generally, the FDC 120 performs operation of matching the stack voltage generated by the fuel cell 110 with the voltage stored in the battery 130, i.e., operation of adjusting the stack voltage to the voltage range of the battery 130. For example, while the level of the stack voltage is about 100 V to about 200 V, the voltage level of the battery 130 is about 600 V. Accordingly, the FDC 120 may operate as a type of boost converter that boosts the stack voltage to 600 V.

The battery 130 stores the boosted voltage output from the FDC 120.

The controller 170 serves to generate a control signal to control the operation of the FDC 120. In addition, the controller 170 may control transfer of the boosted voltage from the FDC 120 to the battery 130. To this end, the fuel cell vehicle 100 may further include a switching unit 140. Under the control of the controller 170, the switching unit 140 may be switched on to supply the boosted voltage to the battery 130. To this end, the switching unit 140 may include a first switch (or relay) SW1 and a second switch (or relay) SW2. The first switch SW1 and the second switch SW2 may be disposed between the FDC 120 and the battery 130, and may be switched under the control of the controller 170.

In addition, the load 150 may include an inverter (not shown) and a motor (not shown). The inverter may be connected to the boosted voltage. The inverter may convert a direct current (DC) voltage supplied from the FDC 120 into an alternating current (AC) voltage according to the driving state of the fuel cell vehicle 100, and may output the AC voltage to the motor. The motor may be driven in response to the AC voltage output from the inverter. In other words, the motor may receive a motor-driving AC voltage from the inverter and rotate to drive the fuel cell vehicle 100. For example, the motor may be a three-phase AC rotating device including a rotor in which permanent magnets are embedded. However, the embodiments are not limited to any specific form of the main output unit, the inverter, or the motor.

In addition, although not shown in the drawings, the fuel cell vehicle 100 may further include a balance of plant (BOP) and high-voltage components.

FIG. 2 is a view showing an embodiment 120A of the voltage level converter 120 shown in FIG. 1. The voltage level converter 120A and the controller 170 shown in FIG. 2 correspond to and perform the same functions as the voltage level converter 120 and the controller 170 shown in FIG. 1, respectively, and thus redundant descriptions thereof have been omitted.

The voltage level converter 120A may be a “multiphase FDC” including a plurality of boost converters connected in parallel to each other. For example, as shown in FIG. 2, the voltage level converter 120A may include first to N^{th} boost converters BS1 to BSN (122 to 126). For example, N is a positive integer greater than or equal to 2.

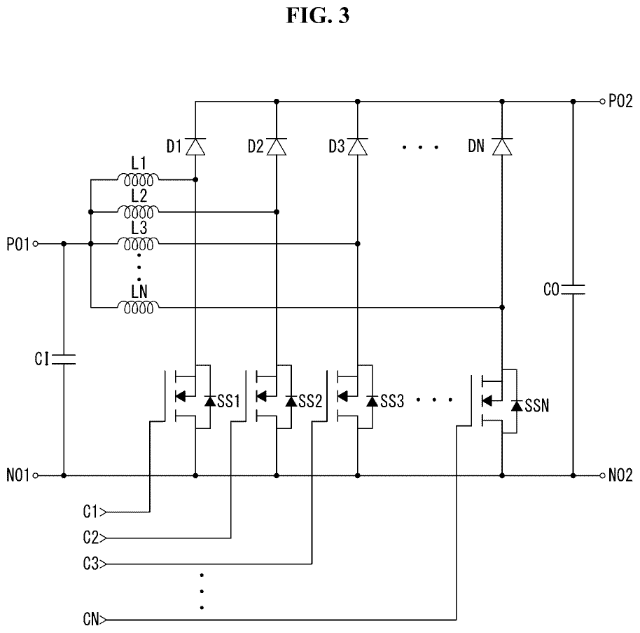

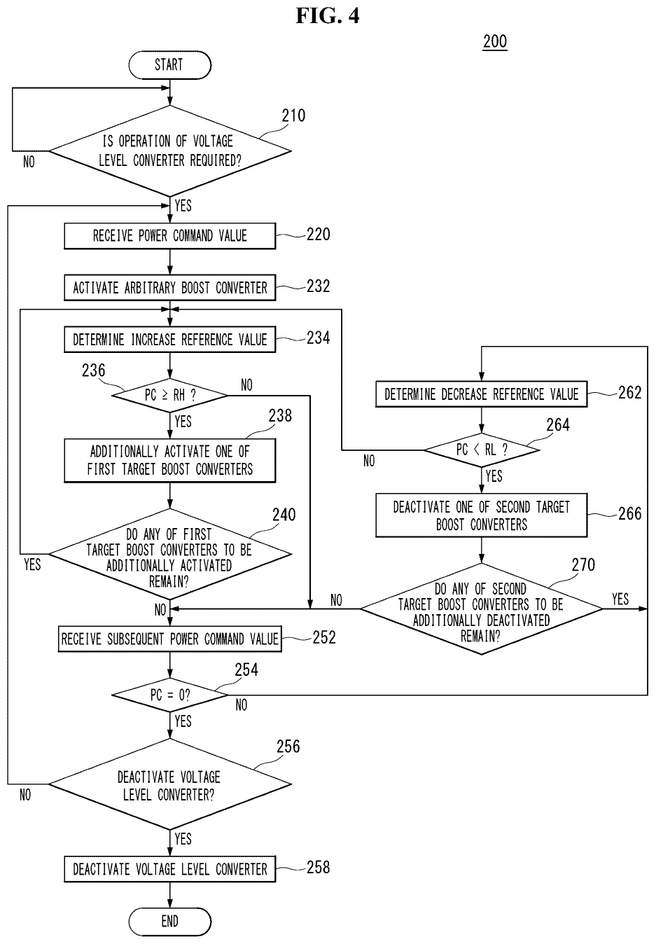

FIG. 3 is a circuit diagram of an embodiment of the voltage level converter 120A shown in FIG. 2.

The voltage level converter 120A shown in FIG. 3 may include an input capacitor CI, first to N^{th} inductors L1 to LN, first to N^{th} diodes D1 to DN, first to N^{th} semiconductor switches SS1 to SSN, and an output capacitor CO.

The input capacitor CI may be connected between a positive output terminal PO1 and a negative output terminal NO1 of the fuel cell 110.

Each of the first to N^{th} inductors L1 to LN has an end connected to the positive output terminal PO1.

Each of the first to N^{th} diodes D1 to DN has a positive electrode connected to the other end of a respective one of the first to N^{th} inductors L1 to LN.

The output capacitor CO may be connected between a negative electrode of each of the first to N^{th} diodes D1 to DN and the negative output terminal NO1.

The first to N^{th} semiconductor switches SS1 to SSN may be connected between the positive electrodes of the first to N^{th} diodes D1 to DN and the negative output terminal NO1. For example, each (SSj) of the first to N^{th} semiconductor switches SS1 to SSN may be switched on (or turned on) or switched off (or turned off) in response to a j^{th} control signal Cj, and may be connected between the other end of the j^{th} inductor Lj and the negative output terminal NO1 of the fuel cell 110. The j^{th} semiconductor switch SSj may include a gate connected to the j^{th} control signal Cj, a drain connected to the other end of the j^{th} inductor Lj, and a source connected to the negative output terminal NO1. For example, 1≤j≤N.

Each (SSj) of the first to N^{th} semiconductor switches SS1 to SSN may be implemented as an insulated gate bipolar transistor (IGBT) or a field effect transistor (FET). For example, each (SSj) of the first to N^{th} semiconductor switches SS1 to SSN may be implemented as a transistor, as shown in FIG. 3.

Generally, the power output from the voltage level converter 120 is about 200 kW (600 A). However, inductors, capacitors, switches, and diodes capable of withstanding this level of current and power are either very expensive or not available. However, as shown in FIGS. 2 and 3, if the boost converters are connected in parallel to each other to implement the voltage level converter 120 as the multiphase FDC 120A, the output power per boost converter may be reduced from 200 kW to 200 kW/N, whereby the cost of the components (i.e., the inductor, the capacitor, the semiconductor switch, and the diode) of each boost converter may be reduced.

In addition, after the N boost converters BS1 to BSN are arranged in parallel as shown in FIG. 3, a desired number of boost converters among the boost converters BS1 to BSN disposed in parallel may be operated according to the output power when the fuel cell vehicle 100 is actually driven. For example, if the power output from the voltage level converter 120A is 70 kW, two boost converters among the N boost converters may be operated, and the remaining boost converters may not be operated. Alternatively, if the power output from the voltage level converter 120A is 140 kW, three boost converters among the N boost converters may be operated, and the remaining boost converters may not be operated. In this way, by varying the number of boost converters operated according to the power output from the multiphase FDC 120A, the overall efficiency of the voltage level converter may be increased.

For example, if the power output from the voltage level converter is 200 kW (600 A) and four (N=4) boost converters are arranged in parallel, the boost converters may be designed and manufactured such that the capacity per boost converter is 50 kW (150 A).

According to the embodiment, the controller 170 may generate control signals C1 to CN based on a result of comparison between an increase reference value RH, determined based on the number of boost converters (hereinafter referred to as “first target boost converters”) that are eligible for additional activation among the first to N^{th} boost converters BS1 to BSN, and a power command value PC of the voltage level converter 120 and based on a result of determining whether any of the first target boost converters to be additionally activated remain.

In addition, the controller 170 may also generate control signals C1 to CN based on a result of comparison between a decrease reference value RL, determined based on the number of boost converters (hereinafter referred to as “second target boost converters”) that are eligible for deactivation among the first to N^{th} boost converters BS1 to BSN (122 to 126), and the power command value PC of the voltage level converter 120 and based on a result of determining whether any of the second target boost converters to be deactivated remain.

In addition, the controller 170 may also generate control signals C1 to CN by sequentially or randomly selecting one of the first target boost converters to be additionally activated, or may also generate control signals C1 to CN by sequentially or randomly selecting one of the second target boost converters to be deactivated.

A method in which the controller 170 generates control signals C1 to CN to control the first to N^{th} boost converters BS1 to BSN (122 to 126) is described below in detail with reference to FIGS. 4 to 6.

Hereinafter, a method 200 of controlling the fuel cell vehicle according to an embodiment is described with reference to the accompanying drawings. For convenience of description, the method 200 shown in FIG. 4 is described as being performed by the fuel cell vehicle 100 shown in FIG. 1, and the voltage level converter 120 is described as being implemented as shown in FIGS. 2 and 3. However, the method 200 shown in FIG. 4 may also be performed by a fuel cell vehicle configured differently from the fuel cell vehicle 100 shown in FIGS. 1 to 3.

FIG. 4 is a flowchart showing the method 200 of controlling the fuel cell vehicle according to the embodiment. The method 200 shown in FIG. 4 may be performed by the controller 170 shown in FIG. 1.

In the method 200 of controlling the fuel cell vehicle according to the embodiment, whether operation of the voltage level converter 120 or 120A is required is first determined (step 210).

If operation of the voltage level converter 120 or 120A is required, the controller 170 receives a power command value (step 220). The power command value may be provided from a higher-level controller (not shown) to the controller 170 and may be inversely proportional to a voltage command value.

For example, referring to FIG. 1, the controller 170 may be requested to operate the voltage level converter 120 and may receive the power command value through the input terminal IN. In other words, the performance of the method 200 shown in FIG. 4 may begin as the voltage level converter 120 starts operating. Upon receiving a command requesting operation of the voltage level converter 120, the controller 170 may perform the control method 200 according to the embodiment shown in FIG. 4 in order to follow the power command value.

After step 220, among the plurality of boost converters BS1 to BSN (122 to 126), one arbitrary boost converter is activated (step 232). For example, the arbitrary boost converter may be randomly selected from among the plurality of boost converters BS1 to BSN (122 to 126).

After step 232, the increase reference value RH is determined based on the number of first target boost converters that are eligible for additional activation among the plurality of boost converters BS1 to BSN (122 to 126) (step 234).

According to the embodiment, the increase reference value RH may be determined as shown in Equation 1 below.

$$R H = \frac{T H}{( K - 1 )} \qquad [ Equation 1 ]$$

In Equation 1, TH represents a predetermined increase threshold, and K represents the number of first target boost converters.

After step 234, it is determined whether the power command value PC of the voltage level converter 120 or 120A is equal to or greater than the increase reference value RH (step 236).

If the power command value PC is equal to or greater than the increase reference value RH, one of the first target boost converters is additionally activated (step 238).

According to one embodiment, one of the first target boost converters to be additionally activated may be sequentially selected. For example, excluding the arbitrary boost converter that has already been activated in step 232, the first to N^{th} boost converters BS1 to BSN (122 to 126) may be sequentially selected as the first target boost converter in that order. For example, after the N^{th} boost converter BSN (126) is selected, the selection may return to the first boost converter BS1 (122) and continue sequentially.

According to another embodiment, one of the first target boost converters to be additionally activated may be randomly selected.

After step 238, it is determined whether any of the first target boost converters to be additionally activated remain (step 240). For example, if all of the first to N^{th} boost converters BS1 to BSN (122 to 126) have already been selected as the first target boost converters, it is determined that none of the first target boost converters to be additionally activated remain.

If any of the first target boost converters to be additionally activated remain, the process proceeds to step 234 in which the increase reference value is determined, and steps 234 to 240 described above are repeatedly performed.

However, if none of the first target boost converters to be additionally activated remain, or if it is determined in step 236 that the power command value PC is less than the increase reference value RH, a subsequent power command value is received (step 252).

After step 252, it is determined whether the subsequent power command value PC is 0 (step 254).

If the subsequent power command value PC is 0, it is determined whether to deactivate the voltage level converter 120 or 120A (step 256). If it is determined to deactivate the voltage level converter 120 or 120A, the voltage level converter 120 or 120A is deactivated (step 258). However, if it is determined not to deactivate the voltage level converter 120 or 120A, the process proceeds to step 220.

On the other hand, if the received power command value PC is not 0, a decrease reference value RL is determined based on the number of second target boost converters that are eligible for deactivation among the plurality of boost converters BS1 to BSN (122 to 126) (step 262).

According to the embodiment, the decrease reference value RL may be determined as shown in Equation 2 below.

$$R L = \frac{T L}{( H - 1 )} \qquad [ Equation 2 ]$$

In Equation 2, TL represents a predetermined decrease threshold, and H represents the number of second target boost converters.

After step 262, it is determined whether the subsequent power command value PC is less than the decrease reference value RL (step 264).

If the subsequent power command value PC is equal to or greater than the decrease reference value RL, the process proceeds to step 234 to determine the increase reference value RH.

However, if the subsequent power command value PC is less than the decrease reference value RL, one of the second target boost converters is deactivated (step 266).

According to one embodiment, one of the second target boost converters to be deactivated may be sequentially selected. For example, if all of the first to N^{th} boost converters BS1 to BSN (122 to 126) are operating, the first to N^{th} boost converters BS1 to BSN (122 to 126) may be sequentially selected as the second target boost converter in that order. For example, after the N^{th} boost converter BSN (126) is selected, the selection may return to the first boost converter BS1 (122) and continue sequentially.

According to another embodiment, one of the second target boost converters to be deactivated may be randomly selected.

After step 266, it is determined whether any of the second target boost converters to be additionally deactivated remain (step 270). If any of the second target boost converters to be additionally deactivated remain, the process proceeds to step 262 to determine the decrease reference value RL. However, if none of the second target boost converters to be additionally deactivated remain, the process proceeds to step 252 to receive a subsequent power command value.

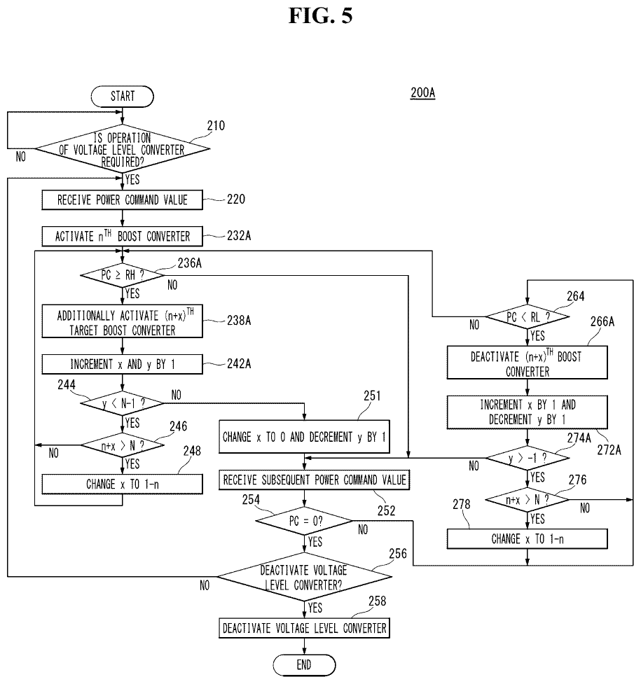

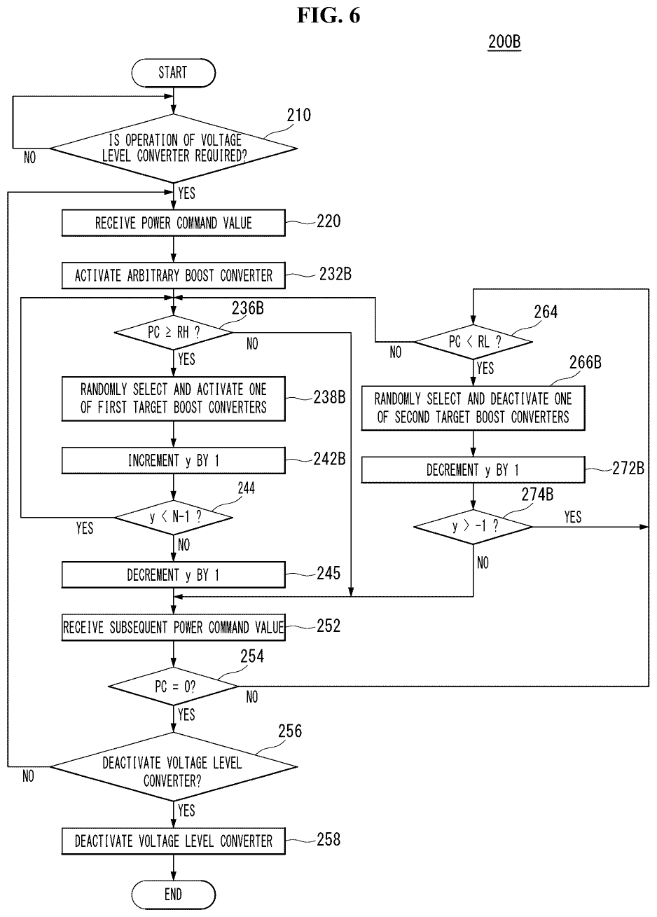

Hereinafter, an embodiment 200A of the method 200 of controlling the fuel cell vehicle shown in FIG. 4 is described with reference to FIG. 5. According to the method 200A of controlling the fuel cell vehicle according to the embodiment, the first target boost converters and the second target boost converters are sequentially selected, respectively. The same reference numerals are used for the steps identical to those in FIG. 4, and a detailed description thereof has been omitted or briefly provided to avoid redundancy.

FIG. 5 is a flowchart showing an embodiment 200A of the method 200 of controlling the fuel cell vehicle shown in FIG. 4.

Steps 210 and 220 are identical to steps 210 and 220 shown in FIG. 4, respectively.

After step 220, among the first to N^{th} boost converters BS1 to BSN (122 to 126), an n^{th} (1≤n≤N−1) boost converter BSn is activated (step 232A). Step 232A corresponds to an embodiment of step 232 shown in FIG. 4. For example, the n^{th} boost converter may be randomly selected from among the plurality of boost converters BS1 to BSN (122 to 126).

After step 232A, it is determined whether the power command value PC of the voltage level converter 120 or 120A is equal to or greater than an increase reference value RH (step 236A). The increase reference value RH is determined as shown in Equation 3 below.

$$R H = \frac{T H}{( N - y )} \qquad [ Equation 3 ]$$

In Equation 3, y represents a first variable, which is initially set to 0. Step 236A corresponds to an embodiment of step 236 shown in FIG. 4. Step 234 shown in FIG. 4 may be performed as part of step 236A or may be performed after step 232A and before step 236A.

Hereinafter, step 234 shown in FIG. 4 is described as being performed as part of step 236A shown in FIG. 5.

If the power command value PC is equal to or greater than the increase reference value RH, an (n+x)^{th} target boost converter BSn+x is additionally activated (step 238A). For example, x represents a second variable, which is initially set to 1. Step 238A corresponds to an embodiment of step 238 shown in FIG. 4.

After step 238A, the first variable y and the second variable x are each incremented by 1 (step 242A). After step 242A, it is determined whether y is less than N−1 (step 244). If y is less than N−1, it is determined whether n+x is greater than N (step 246). If n+x is not greater than N, the process proceeds to step 236A. However, if n+x is greater than N, x is changed to 1-n, and the process proceeds to step 236A (step 248). Steps 242A and 244 may correspond to an embodiment of step 240 shown in FIG. 4.

However, if y is not less than N−1, that is, if none of the first target boost converters to be additionally activated remain, x is changed to 0, and y is decremented by 1 (step 251). After step 251, a new power command value PC is received (step 252). Steps 254 to 258 are identical to steps 254 to 258 shown in FIG. 4, respectively.

If the new power command value PC is not 0, it is determined whether the new power command value PC is less than a decrease reference value RL (step 264). The decrease reference value RL is determined as shown in Equation 4 below.

$$RL = \frac{TL}{( N - y )} \qquad [ Equation 4 ]$$

Step 264 corresponds to step 264 shown in FIG. 4.

If the new power command value PC is equal to or greater than the decrease reference value RL, the process proceeds to step 236A.

However, if the new power command value PC is less than the decrease reference value RL, the (n+x)^{th} boost converter BSn+x is deactivated (step 266A). Step 266A corresponds to an embodiment of step 266 shown in FIG. 4.

After step 266A, x is incremented by 1, and y is decremented by 1 (step 272A).

After step 272A, it is determined whether y is greater than −1 (step 274A). If y is not greater than −1, the process proceeds to step 252.

However, if y is greater than −1, it is determined whether n+x is greater than N (step 276). If n+x is not greater than N, the process proceeds to step 264. However, if n+x is greater than N, x is changed to 1−n, and the process proceeds to step 264 (step 278). Steps 272A and 274A correspond to an embodiment of step 270 shown in FIG. 4.

Hereinafter, to aid in understanding the embodiment 200A shown in FIG. 5, the embodiment 200A shown in FIG. 5 is described on the assumption that N is 5, TH is 150, TL is 120, n is 3, and the first power command value is 200.

After step 220, the third boost converter BS3 is activated (step 232A).

After step 232A, it is determined whether the power command value PC is equal to or greater than the increase reference value RH (step 236A). If the corresponding values are substituted into Equation 3 described above, the increase reference value RH is determined as shown in Equation 5 below.

$$RH = \frac{150}{( 5 - 0 )} = 30 \qquad [ Equation 5 ]$$

As described above, in Equation 3, the first variable y is initially set to 0.

Because the power command value PC, which is 200, is greater than the increase reference value RH, which is 30, the fourth boost converter BS4 is additionally activated (step 238A). Because the second variable x is initially set to 1, the (n+x)^{th} (=3+1=4) boost converter corresponds to the fourth boost converter BS4.

After step 238A, x and y are each incremented by 1 such that x becomes 2 and y becomes 1 (step 242A).

After step 242A, it is determined in step 244 that y (=1) is less than N−1 (=5−1=4), and the process proceeds to step 246.

It is determined in step 246 that n+x (=3+2=5) is not greater than N(=5), and the process proceeds to step 236A.

If the corresponding value (y=1) is substituted into Equation 3, the increase reference value RH is determined as shown in Equation 6 below.

$$RH = \frac{150}{( 5 - 1 )} = 37.5 \qquad [ Equation 6 ]$$

Because the power command value PC, which is 200, is still greater than the increase reference value RH, which is 37.5, in step 236A, the fifth boost converter BS5 is additionally activated (step 238A). Because the second variable x has been incremented to 2 in step 242A, the (n+x)^{th} (=3+2=5) boost converter corresponds to the fifth boost converter BS5.

After step 238A, x and y are each incremented by 1 such that x becomes 3 and y becomes 2 (step 242A).

After step 242A, it is determined in step 244 that y (=2) is less than N−1 (=4), and the process proceeds to step 246.

It is determined in step 246 that n+x (=3+3=6) is greater than N(=5), and the process proceeds to step 248.

In step 248, x incremented to 3 in step 242A is changed to 1−n (=1−3=−2), and the process proceeds to step 236A.

If the corresponding value (y=2) is substituted into Equation 3, the increase reference value RH is determined as shown in Equation 7 below.

$$RH = \frac{150}{( 5 - 2 )} = 50 \qquad [ Equation 7 ]$$

Because the power command value PC, which is 200, is still greater than the increase reference value RH, which is 50, in step 236A, the first boost converter BS1 is additionally activated (step 238A). Because the second variable x has been changed to −2 in step 248, the (n+x)^{th} (=3−2=1) boost converter corresponds to the first boost converter BS1.

In this way, according to the embodiment, after the fifth boost converter BS5 is activated, the first boost converter BS1 is activated.

After step 238A, x and y are each incremented by 1 such that x becomes −1 and y becomes 3 (step 242A).

After step 242A, it is determined in step 244 that y (=3) is less than N−1 (=4), and the process proceeds to step 246.

It is determined in step 246 that n+x (=3−1=2) is not greater than N(=5), and the process proceeds to step 236A.

If the corresponding value (y=3) is substituted into Equation 3, the increase reference value RH is determined as shown in Equation 8 below.

$$RH = \frac{150}{( 5 - 3 )} = 75 \qquad [ Equation 8 ]$$

Because the power command value PC, which is 200, is still greater than the increase reference value RH, which is 75, in step 236A, the second boost converter BS2 is additionally activated (step 238A). Because the second variable x has been incremented to −1 in step 242A, the (n+x)^{th} (=3−1=2) boost converter corresponds to the second boost converter BS2.

After step 238A, x and y are each incremented by 1 such that x becomes 0 and y becomes 4 (step 242A).

After step 242A, it is determined in step 244 that y (=4) is not less than N−1 (=4), and the process proceeds to step 251.

As described above, the five boost converters are sequentially activated in the order of the third, fourth, fifth, first, and second boost converters BS3, BS4, BS5, BS1, and BS2.

Subsequently, in step 251, x is changed to 0, and y (=4) is decremented by 1 to become 3.

After step 251, a new power command value is received (step 252). It is assumed that the new power command value received following the power command value of 200 is 20.

Because the new power command value PC is not 0, the process proceeds to step 264.

If the corresponding values (TL=120 and y=3) are substituted into Equation 4, the decrease reference value RL is determined as shown in Equation 9 below.

$$RL = \frac{120}{( 5 - 3 )} = 60 \qquad [ Equation 9 ]$$

Because the power command value PC, which is 20, is less than the decrease reference value RL, which is 60, in step 264, the third boost converter BS3 is deactivated (step 266A). Because the second variable x has been changed to 0 in step 251, the (n+x)^{th} (=3+0=3) boost converter corresponds to the third boost converter BS3 in step 266A.

After step 266A, x is incremented by 1 to become 1, and y is decremented by 1 to become 2 (step 272A).

After step 272A, it is determined in step 274A that y (=2) is greater than −1, and it is determined in step 276 that n+x (=3+1=4) is not greater than N(=5). The process proceeds to step 264.

If the corresponding value (y=2) is substituted into Equation 4, the decrease reference value RL is determined as shown in Equation 10 below.

$$RL = \frac{120}{( 5 - 2 )} = 40 \qquad [ Equation 10 ]$$

Because the power command value PC, which is 20, is less than the decrease reference value RL, which is 40, in step 264, the fourth boost converter BS4 is deactivated (step 266A). Because the second variable x has been incremented to 1 in step 272A, the (n+x)^{th} (=3+1=4) boost converter corresponds to the fourth boost converter BS4 in step 266A.

After step 266A, x is incremented by 1 to become 2, and y is decremented by 1 to become 1 (step 272A).

After step 272A, it is determined in step 274A that y (=1) is greater than −1, and it is determined in step 276 that n+x (=3+2=5) is not greater than N(=5). The process proceeds to step 264.

If the corresponding value (y=1) is substituted into Equation 4, the decrease reference value RL is determined as shown in Equation 11 below.

$$RL = \frac{120}{( 5 - 1 )} = 30 \qquad [ Equation 11 ]$$

Because the power command value PC, which is 20, is less than the decrease reference value RL, which is 30, in step 264, the fifth boost converter BS5 is deactivated (step 266A). Because the second variable x has been incremented to 2 in step 272A, the (n+x)^{th} (=3+2=5) boost converter corresponds to the fifth boost converter BS5 in step 266A.

After step 266A, x is incremented by 1 to become 3, and y is decremented by 1 to become 0 (step 272A).

After step 272A, it is determined in step 274A that y (=0) is greater than −1, and it is determined in step 276 that n+x (=3+3=6) is greater than N(=5). The process proceeds to step 278.

In step 278, x is changed to 1−n (=1−3=−2), and the process proceeds to step 264.

If the corresponding value (y=0) is substituted into Equation 4, the decrease reference value RL is determined as shown in Equation 12 below.

$$RL = \frac{120}{( 5 - 0 )} = 24 \qquad [ Equation 12 ]$$

Because the power command value PC, which is 20, is less than the decrease reference value RL, which is 24, in step 264, the first boost converter BS1 is deactivated (step 266A). Because the second variable x has been changed to −2 in step 278, the (n+x)^{th} (=3−2=1) boost converter corresponds to the first boost converter BS1.

After step 266A, x is incremented by 1 to become −1, and y is decremented by 1 to become −1 (step 272A).

After step 272A, it is determined in step 274A that y (=−1) is not greater than −1, and the process proceeds to step 252.

As described above, the four boost converters are sequentially deactivated in the order of the third, fourth, fifth, and first boost converters BS3, BS4, BS5, and BS1.

Hereinafter, another embodiment 200B of the method 200 of controlling the fuel cell vehicle shown in FIG. 4 is described with reference to FIG. 6. According to the method 200B of controlling the fuel cell vehicle according to the other embodiment, the first target boost converters and the second target boost converters are randomly selected, respectively. The same reference numerals are used for the steps identical to those in FIG. 4, and a detailed description thereof has been omitted or briefly provided to avoid redundancy.

FIG. 6 is a flowchart showing another embodiment 200B of the method 200 of controlling the fuel cell vehicle shown in FIG. 4.

Steps 210 and 220 are identical to steps 210 and 220 shown in FIG. 4, respectively.

After step 220, among the first to N^{th} boost converters BS1 to BSN (122 to 126), an arbitrary boost converter is activated (step 232B). Step 232B corresponds to an embodiment of step 232 shown in FIG. 4.

After step 232B, it is determined whether the power command value PC of the voltage level converter 120 or 120A is equal to or greater than the increase reference value RH defined in Equation 3 described above (step 236B). Step 236B corresponds to an embodiment of step 236 shown in FIG. 4. Step 234 shown in FIG. 4 may be performed as part of step 236B or may be performed after step 232B and before step 236B. Hereinafter, for convenience of description, step 234 shown in FIG. 4 is described as being performed as part of step 236B.

After step 236B, among the first to N^{th} boost converters BS1 to BSN (122 to 126), one of the first target boost converters that are eligible for additional activation is randomly selected and additionally activated (step 238B). Step 238B corresponds to an embodiment of step 238 shown in FIG. 4.

After step 238B, the first variable y is incremented by 1 (step 242B). After step 242B, it is determined whether y is less than N−1 (step 244). If y is less than N−1, the process proceeds to step 236B. However, if y is not less than N−1, y is decremented by 1 (step 245). Steps 242B and 244 may correspond to an embodiment of step 240 shown in FIG. 4.

After step 245, a new power command value PC is received (step 252). Steps 254 to 258 are identical to steps 254 to 258 shown in FIG. 4, respectively.

If the new power command value PC received in step 252 is not 0, it is determined whether the new power command value PC is less than the decrease reference value RL defined in Equation 4 described above (step 264). Step 264 corresponds to step 264 shown in FIG. 4.

If the new power command value PC is equal to or greater than the decrease reference value RL, the process proceeds to step 236B.

However, if the new power command value PC is less than the decrease reference value RL, one of the second target boost converters that are eligible for additional deactivation among the first to N^{th} boost converters BS1 to BSN (122 to 126) is randomly selected and deactivated (step 266B). Step 266B corresponds to an embodiment of step 266 shown in FIG. 4.

After step 266B, y is decremented by 1 (step 272B).

After step 272B, it is determined whether y is greater than −1 (step 274B). If y is not greater than −1, the process proceeds to step 252.

However, if y is greater than −1, the process proceeds to step 264. Steps 272B and 274B correspond to an embodiment of step 270 shown in FIG. 4.

According to the method 200 (200A and 200B) of controlling the fuel cell vehicle according to the embodiment, as the power command value PC of the voltage level converter increases, the number of boost converters to be activated among the plurality of boost converters BS1 to BSN (122 to 126) is increased.

As shown in FIG. 3, the plurality of boost converters BS1 to BSN (122 to 126) may include semiconductor switches SS1 to SSN, respectively, and the semiconductor switches SS1 to SSN may have different durabilities depending on the number of switching operations thereof. For example, a semiconductor switch included in a boost converter that is always operated may have relatively short durability, whereas a semiconductor switch included in a boost converter that is operated last may have relatively long durability. Therefore, in order to replace the semiconductor switch having the shortest durability, it is necessary to replace the voltage level converter. Accordingly, the durability of the voltage level converter is ultimately determined by the durability of the semiconductor switch having the shortest lifespan.

In consideration of the above, according to the embodiment, the plurality of boost converters is sequentially or randomly activated or deactivated with reference to an arbitrary boost converter. Accordingly, it is possible to prevent a specific boost converter among the plurality of boost converters from being operated intensively, thereby minimizing a difference in the number of switching operations of the semiconductor switches included in the respective boost converters and thus making the durability of the plurality of semiconductor switches substantially uniform. As a result, the embodiment may improve the service life of the voltage level converter 120 or 120A.

In addition, in the embodiment, the boost converters are activated or deactivated using the increase reference value RH and the decrease reference value RL, which are defined by the increase threshold TH and the decrease threshold TL. As a result, stable operation may be achieved even when the power command value PC of the voltage level converter 120 or 120A fluctuates.

As is apparent from the above description, according to the fuel cell vehicle and the method of controlling the same according to the embodiments, the service life of the voltage level converter may be improved, and stable operation may be achieved even when the power command value of the voltage level converter fluctuates.

However, the effects achievable through the disclosure are not limited to the above-mentioned effects, and other effects not mentioned herein should be clearly understood by those having ordinary skill in the art from the above description.

The above-described various embodiments may be combined with each other without departing from the scope of the present disclosure unless they are incompatible with each other.

In addition, for any element or process that is not described in detail in any of the various embodiments, reference may be made to the description of an element or a process having the same reference numeral in another embodiment, unless otherwise specified.

While the present disclosure has been particularly shown and described with reference to example embodiments thereof, these embodiments are only proposed for illustrative purposes, and do not restrict the present disclosure. It should also be apparent to those having ordinary skill in the art that various changes in form and detail may be made without departing from the essential characteristics of the embodiments set forth herein. For example, respective configurations set forth in the embodiments may be modified and applied. Further, differences in such modifications and applications should be construed as falling within the scope of the present disclosure as defined by the appended claims.

1. A method of controlling a fuel cell vehicle comprising a fuel cell, a voltage level converter including a plurality of boost converters connected in parallel to each other and configured to boost stack voltage generated by the fuel cell, and a battery configured to store voltage output from the voltage level converter, the method comprising:
activating an arbitrary boost converter among the plurality of boost converters;
determining an increase reference value based on a number of first target boost converters eligible for additional activation among the plurality of boost converters;
additionally activating one of the first target boost converters based on determining that a power command value of the voltage level converter is equal to or greater than the increase reference value;
determining whether any of the first target boost converters to be additionally activated remain; and
performing determining the increase reference value based on determining that any of the first target boost converters to be additionally activated remain.

2. The method according to claim 1, wherein one of the first target boost converters to be additionally activated is sequentially selected.

3. The method according to claim 1, wherein one of the first target boost converters to be additionally activated is randomly selected.

4. The method according to claim 1, wherein the increase reference value is determined as follows:
$$RH = \frac{TH}{( K - 1 )}$$
where RH represents the increase reference value, TH represents a predetermined increase threshold, and K represents the number of first target boost converters.

5. The method according to claim 1, further comprising:
determining a decrease reference value based on a number of second target boost converters eligible for deactivation among the plurality of boost converters;
deactivating one of the second target boost converters based on determining that a subsequent power command value received following the power command value is less than the decrease reference value;
determining whether any of the second target boost converters to be additionally deactivated remain; and
performing determining the decrease reference value based on determining that any of the second target boost converters to be additionally deactivated remain.

6. The method according to claim 5, wherein one of the second target boost converters to be deactivated is sequentially selected.

7. The method according to claim 5, wherein one of the second target boost converters to be deactivated is randomly selected.

8. The method according to claim 5, wherein the decrease reference value is determined as follows:
$$RL = \frac{TL}{( H - 1 )}$$
where RL represents the decrease reference value, TL represents a predetermined decrease threshold, and H represents the number of second target boost converters.

9. The method according to claim 5, further comprising performing determining the increase reference value based on determining that the subsequent power command value is equal to or greater than the decrease reference value.

10. The method according to claim 5, further comprising:
receiving the power command value based on determining operation of the voltage level converter; and
receiving the subsequent power command value based on determining that none of the first or second target boost converters to be additionally activated or deactivated remain or that the power command value is less than the increase reference value.

11. The method according to claim 10, further comprising:
determining whether the subsequent power command value is 0;
performing determining the decrease reference value based on determining that the subsequent power command value is not 0; and
determining whether to deactivate the voltage level converter based on determining that the subsequent power command value is 0.

12. A method of controlling a fuel cell vehicle comprising a fuel cell, a voltage level converter including first to N^{th} (N being a positive integer of 2 or greater) boost converters connected in parallel to each other and configured to boost stack voltage generated by the fuel cell, and a battery configured to store voltage output from the voltage level converter, the method comprising:
(I) activating an n^{th} (1≤n≤N−1) boost converter among the first to N^{th} boost converters;
(II) determining whether a power command value of the voltage level converter is equal to or greater than an increase reference value defined as follows:
$$RH = \frac{TH}{( N - y )}$$
where RH represents the increase reference value, TH represents a predetermined increase threshold, and y represents a first variable initially set to 0;
(III) additionally activating an (n+x)^{th} target boost converter (x being a second variable initially set to 1);
(IV) incrementing the first variable and the second variable by 1;
(V) determining whether y is less than N−1;
(VI) determining whether n+x is greater than N based on determining that y is less than N−1 and performing step (II) based on determining that n+x is not greater than N; and
(VII) changing x to 1−n based on determining that n+x is greater than N and performing step (II).

13. The method according to claim 12, further comprising:
(VIII) decrementing y by 1 and changing x to 0 based on determining that y is not less than N−1;
(IX) receiving a new power command value;
(X) determining whether the new power command value is less than a decrease reference value based on determining that the new power command value is not 0 and performing step (II) based on determining that the new power command value is equal to or greater than the decrease reference value, the decrease reference value being defined as:
$$RL = \frac{TL}{( N - y )}$$
where RL represents the decrease reference value, and TL represents a predetermined decrease threshold;
(XI) deactivating the (n+x)^{th} boost converter based on determining that the new power command value is less than the decrease reference value;
(XII) incrementing x by 1 and decrementing y by 1;
(XIII) determining whether y is greater than −1 and performing step (IX) based on determining that y is not greater than −1;
(XIV) determining whether n+x is greater than N based on determining that y is greater than −1 and performing step (X) based on determining that n+x is not greater than N; and
(XV) changing x to 1−n based on determining that n+x is greater than N and performing step (X).

14. The method according to claim 13, further comprising determining whether to deactivate the voltage level converter based on determining that the new power command value is 0.

15. A method of controlling a fuel cell vehicle comprising a fuel cell, a voltage level converter including first to N^{th} (N being a positive integer of 2 or greater) boost converters connected in parallel to each other and configured to boost stack voltage generated by the fuel cell, and a battery configured to store voltage output from the voltage level converter, the method comprising:
(I) activating an arbitrary boost converter among the first to N^{th} boost converters;
(II) determining whether a power command value of the voltage level converter is equal to or greater than an increase reference value defined as follows:
$$RH = \frac{TH}{( N - y )}$$
where RH represents the increase reference value, TH represents a predetermined increase threshold, and y represents a first variable initially set to 0;
(III) randomly selecting and additionally activating one of first target boost converters eligible for additional activation among the first to N^{th} boost converters;
(IV) incrementing y by 1; and
(V) determining whether y is less than N−1 and performing step (II) based on determining that y is less than N−1.

16. The method according to claim 15, further comprising:
(VI) decrementing y by 1 based on determining that y is not less than N−1;
(VII) receiving a new power command value;
(VIII) determining whether the new power command value is less than a decrease reference value defined based on determining that the new power command value is not 0 and performing step (II) based on determining that the new power command value is equal to or greater than the decrease reference value, the decrease reference value being defined as:
$$RL = \frac{TL}{( N - y )}$$
where RL represents the decrease reference value, and TL represents a predetermined decrease threshold;
(IX) randomly selecting and deactivating one of second target boost converters eligible for additional deactivation among the first to N^{th} boost converters based on determining that the new power command value is less than the decrease reference value;
(X) decrementing y by 1; and
(XI) determining whether y is greater than −1, performing step (VII) based on determining that y is not greater than −1, and performing step (VIII) based on determining that y is greater than −1.

17. The method according to claim 16, further comprising determining whether to deactivate the voltage level converter based on determining that the new power command value is 0.
